(19) United States
(12) Patent Application Publication
(10) Pub. No.: US 2024/0054566 A1
(43) Pub. Date: Feb. 15, 2024

(54) AGENT FACING QUOTING APPLICATION

(71) Applicant: Goosehead Financial, LLC, Westlake, TX (US)

(72) Inventors: Brian Pattillo, Westlake, TX (US); Casey Bomar, Westlake, TX (US); Sai Varma RAGHAVARAJU, Westlake, TX (US)

(73) Assignee: Goosehead Financial, LLC, Westlake, TX (US)

(21) Appl. No.: 18/232,803

(22) Filed: Aug. 10, 2023

Related U.S. Application Data
(60) Provisional application No. 63/396,870, filed on Aug. 10, 2022.

(51) Int. Cl. G06Q 40/08

(52) U.S. Cl. CPC G06Q 40/08

(57) ABSTRACT

A method and graphical user interface are provided in an agent facing computer system. A progressive graphical user interface (GUI) is generated, comprising a plurality of pages logically arranged into a workflow. First data about a user is e into a first subset of the pages. A set of data sources is queried to identify second data. The set of data sources stores the second data in data records associated with the first data. A second subset of the pages is prepopulated with the first data and the second data. A plurality of API calls is generated from a third subset of pages to a plurality of web services. Each API request comprises at least a portion of the first data and the second data, mapped to a corresponding input for the web service. Responses from the web services are presented in a fourth subset of pages.

### CROSS-REFERENCE TO RELATED APPLICATIONS

This application claims the benefit of U.S. Provisional Application Ser. No. 63/396,870, filed Aug. 10, 2022, and entitled “DIGITAL AGENT,” which is hereby incorporated by reference for all purposes.

### BACKGROUND

Applying for insurance may be an involved process. even when utilizing online application systems, the application process can be time intensive. This application and issuance process typically requires the sequential occurrence of several steps.

Application: The insurance agent guides the potential policyholder through the process of applying for insurance coverage. The application typically includes information about the policyholder's personal and financial information, as well as details about the type of coverage being applied for. The user will be asked to provide demographic information, driving records, and other information. After deciding on what to insure, applicants may select one or more insurance carriers. Because insurers may not evaluate the same criteria, they may require different information.

Underwriting: The insurance company reviews the application and conducts an underwriting process to determine the policyholder's risk profile and whether they are eligible for coverage. This process may include a review of the policyholder's credit score, medical history, and other relevant information. Based on this information, the insurance agent will provide the policyholder with a quote for the coverage.

Quote: Once the underwriting process is complete, the insurance company will provide the agent with a premium quote, which is the cost of the coverage. Once the policy has been quoted, the agent can review the coverage options with the policyholder and decide if they would like to add any endorsements to their policy. These additional coverage options or discounts can be added as an endorsement to the policy, which will then be reviewed and approved by the insurance company. The policyholder will have the option to accept or decline the quote.

Acceptance: If the policyholder accepts the premium quote, they will be required to provide payment information in order to bind the policy. Binding an insurance policy means that the policy is in effect and the insurance company is obligated to provide coverage according to the terms of the policy. Once a policy is bound, the insurance company is required to pay claims that are covered under the policy, subject to any exclusions or limitations. Binding typically occurs after the policyholder has applied for coverage, the insurance company has reviewed the application and determined that the policyholder is eligible for coverage, and the policyholder has provided payment information.

Binding refers to the process of making the policy legally effective. Binding an insurance policy is similar to the execution of a contract. An insurance policy is a contract between the insurance company and the policyholder, in which the insurance company agrees to provide coverage in exchange for the policyholder paying premiums. Binding the policy signifies that both parties have agreed to the terms of the contract and are legally bound to fulfill their respective obligations. The insurance company is obligated to provide coverage as outlined in the policy, and the policyholder is obligated to pay the premiums.

Policy issuance: Once the first payment has been made or payment information has been provided for a future payment, the insurance company will issue a policy, which will include all the details of the coverage and the terms of the contract. This signifies that the policy is now bound and both parties are legally bound to fulfill their respective obligations. Issuance refers to the process of creating and providing the policyholder with a physical or digital copy of the policy document. This document contains all the details of the coverage, including the policyholder's personal information, coverage limits, exclusions, and other valuable information.

The assessment of an applicant may be subjective. It is common for different insurers to provide an applicant with different rates, different coverage levels, and different terms. Thus, in order to effectively compare policies, user must often resubmit information or provide additional information to each of the different carriers interface. In other words, current systems do not provide a semi-automated or automated system for quoting insurance products in the absence of live agent intervention.

### SUMMARY

One or more aspects of the invention provide for a method and graphical user interface in an agent facing computer system. The method includes generating a progressive graphical user interface (GUI). The progressive GUI comprises a plurality of pages, with each page presenting a specific task logically arranged into a workflow. The method includes receiving into a first subset of the plurality of pages of the progressive GUI, first data about a user that is input from a client device. The method includes querying a set of data sources to identify second data. The set of data sources stores the second data in data records that are associated with the first data. The method includes prepopulating a second subset of the plurality of pages with the first data and the second data. The method includes generating, from a third subset of the plurality of pages, a plurality of API calls to a plurality of web services. Each API request comprises at least a portion of the first data and the second data that is mapped to a corresponding input for the web service. The method includes presenting, in a fourth subset of the plurality of pages, a plurality of responses from the web services.

Other aspects of the invention will be apparent from the following description and the appended claims.

### BRIEF DESCRIPTION OF DRAWINGS

FIG. 1 shows a computing system in accordance with one or more embodiments of the invention.

FIG. 2 shows a transformer architecture in accordance with one or more embodiments of the invention.

FIG. 3 shows a system flow diagram in accordance with one or more embodiments of the invention.

FIG. 4 shows a method in an agent facing computer system in accordance with one or more embodiments of the invention.

FIGS. 5A and 5B are first pages of a progressive graphical user interface in accordance with one or more embodiments of the invention.

FIGS. 6A, 6B and 6C are second pages of the progressive graphical user interface in accordance with one or more embodiments of the invention.

FIG. 7 is a third page of the progressive graphical user interface in accordance with one or more embodiments of the invention.

FIG. 8 is a fourth page of the progressive graphical user interface in accordance with one or more embodiments of the invention.

FIGS. 9A, 9B and 9C are fifth pages of the progressive graphical user interface in accordance with one or more embodiments of the invention.

FIGS. 10A, 10B and 10C are sixth pages of the progressive graphical user interface in accordance with one or more embodiments of the invention.

FIG. 11 is a seventh page of the progressive graphical user interface in accordance with one or more embodiments of the invention.

FIG. 12 is an eighth page of the progressive graphical user interface in accordance with one or more embodiments of the invention.

FIGS. 13A and 13B show a computing system in accordance with one or more embodiments of the invention.

Like elements in the various figures are denoted by like reference numerals for consistency.

### DETAILED DESCRIPTION

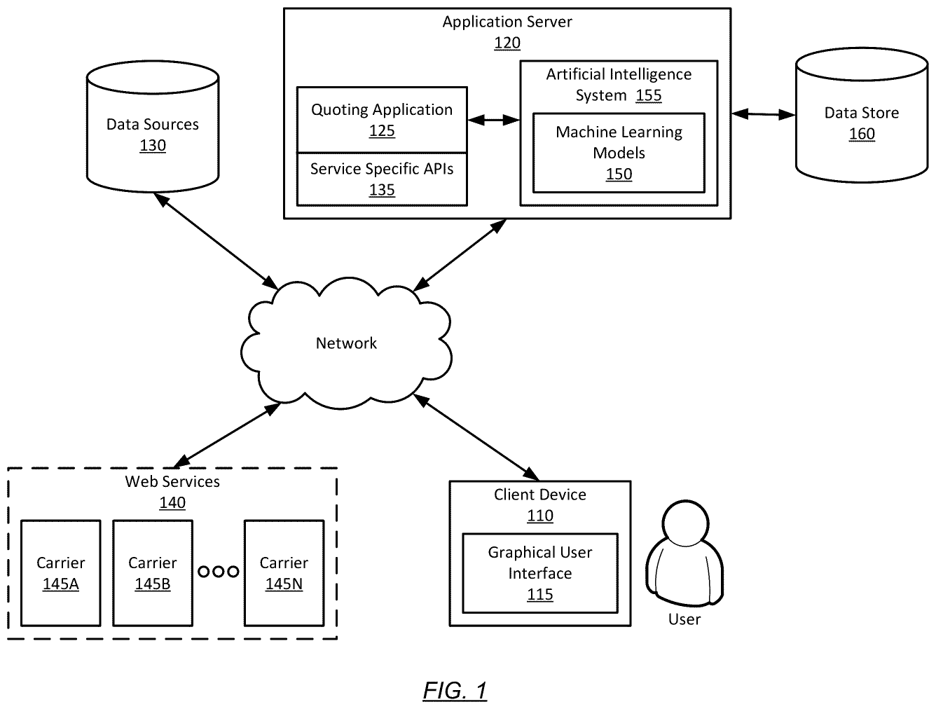

FIG. 1 is a computing environment according to illustrative embodiments. The computing environment of FIG. 1 provides an insurance quoting and sales system that enables users of client device (110) to obtain insurance product offerings from multiple third-party vendors that provide insurance or may be associated with providing insurance. The client device (110) may be for example, a mobile device, wireless device, local or remote stand-alone desktop or portable computer or controller that may execute various computer applications.

The client device (110) may access a front-end application server (120) communicating with a number of back-end data sources (130) and web services (140). Either or both of the client device (110) or application server (120) may store, and format user submitted information, either temporarily or permanently, to efficiently obtained information from web services (140) while reducing the amount of data entry required in a quoting process.

The client device may include a graphical user interface (GUI) (115) that utilizes a progressive disclosure interaction design pattern. The progressive disclosure of GUI (115) sequences information and actions across several screens as the user progresses through information submission and receipt for binding an insurance policy after receiving quotes from the various web services (140). By disclosing information progressively, the GUI (115) reveals only the as-needed essentials, helping users manage the complexity of feature-rich websites or applications and lowering the chances that users will feel overwhelmed by the transaction.

The GUI (115) interacts with logic of the quoting application (125) to determine a sequence and inclusivity for information that is progressively displayed that may mimic the thought process of a live agent. For example, where a selected value is not available for a next question, the quoting application may remove that option from the displayed sequence of information.

Quoting application (125) can be run in a remote location on application server (120). In another illustrative example, quoting application (125) can run on client device (110) and can take the form of a system instance of the application. In yet other illustrative examples, quoting application (125) can be distributed in multiple locations across a network of computer systems. For example, quoting application (125) can run on client device (110) and application server (120) depending on the particular implementation.

In some embodiments, GUI (115) is a progressive GUI. A progressive GUI may also be referred to as a sequential GUI, a linear GUI, linear flow GUI, step-by-step GUI, or wizard. A progressive GUI is a type of interface that guides users through a series of steps or tasks in a specific order. In this embodiment, GUI (115) is organized as a series of screens or pages, with the user moving from one screen to the next in a linear fashion. Each screen or page presents the user with a specific task or set of options that the user must complete or select one before moving on to the next. Thus, the progressive structure enables GUI (115) to guide users through complex processes or tasks in software applications that require multiple steps, such as applying for an insurance policy.

As compared to a regular (or non-sequential) GUI, the sequential design of GUI (115) offers several benefits. For example, GUI (115) simplifies the user experience by breaking down a complex process or task into smaller, manageable steps, making the application process easier for users to understand and complete. The linear structure of a GUI (115) provides clear guidance for users, making the overall process easy for users to understand and what their next steps should be. The linear structure of a progressive interface makes GUI (115) easier to learn and use than other GUIs, enabling users more easily to understand the flow and structure of the application.

GUI (115) can simplify onboarding new users, as it guides them through the process of getting started with a new software or app. GUI (115) can improve efficiency by enabling users to accomplish a task faster and easier through clear guidance and reducing the need for users to navigate through multiple screens or options. By guiding users through a process step by step, GUI (115) can help prevent errors by ensuring that the user completes all necessary steps and enters all necessary information.

Thus, GUI (115) solves problems of prior graphical user interface devices (GUIs), in the context of computerized insurance transactions, relating to speed, accuracy, and usability. Rather than reciting a mathematical algorithm, a fundamental economic or longstanding commercial practice, or a challenge in business, graphical user interface (1) improves on existing interface devices that do not have a pre-electronic analog. The embodiments of GUI (115) provide significantly more than prior graphical user interface devices that merely allow for setting, displaying, and selecting data or information that is visible on a GUI. Instead, GUI (115) utilizes a specific, structured interface related a prescribed functionality that resolves a specifically identified problem of obtaining online insurance quotes.

Furthermore, the specific structure and concordant functionality of GUI (115) distinguishes this system as compared to conventional computer implementations of known procedures. The function of GUI (115) is not simply the generalized use of client device (110) as a tool to conduct a known or obvious process. Instead, GUI (115) provides an inventive concept that allows users to submit requests and visualize comparisons of quotes provided by different web services (140) more efficiently and accurately. Rather than the routine or conventional use of computers or the Internet, GUI (115) overcomes problems that are necessarily rooted in computer technology and that specifically arise in the realm of computer networks, resulting in an improvement to the capabilities of the computer system.

Application server (120) may retrieve information from one or more third-party data sources (130) to prefill or autosuggest data to the client device (110) to populate one or more input fields (e.g., templates, online applications, forms, etc.) that may be transmitted to the Quoting application (125). Information retrieved from data sources (130) may also be submitted from application server to various web services (140) via one or more application programming interfaces (APIs) to obtain an insurance quote from one or more carriers (145A-145N).

In some illustrative embodiments, the one or more web services (140) comprise a microservices event-based architecture. A microservices architecture is a software design pattern that structures an application as a collection of loosely coupled, small, independent services. Each microservice is designed to perform a specific business function and can be deployed and executed independently of other services. This separation of services allows for greater flexibility, scalability, and maintainability compared to a monolithic architecture, where an application is built as a single, tightly coupled entity.

Web services (140) may be associated with providing insurance service by one or more third-party carriers (145A-145N). Different carriers (145A-145N), corresponding to different web services (140), may require different data for generating a quote. Gathering and submitting this data is often a collaborative process with each carrier. For example, while not required by most carriers, one integration may require a driver's license number for the purposes of returning the quotes and may not return quotes without the requisite information. The quoting application may utilize custom APIs having implementation specific endpoints that are directly integrated with the web services (140). APIs for these direct integrations are built to return an initial quote.

Web services (140) may use the information submitted by the user to client device (110) to make underwriting decisions regarding insurance policies and rates. Upon receiving the information from application server (120), web services (140) may be configured to provide a quote for an insurance policy. Demographic, insurance, financial, and/or other data from a user and/or third-party data sources may be quantified by the system (e.g., in some cases, translated into numerical values, ratings, or scores based on a numerical point scale) to determine the viability or likelihood a user may qualify and/or may accept an offer of insurance from one or more insurance carriers.

In some illustrative embodiments, the one or more web services (140) comprise a microservices event-based architecture. A microservices architecture is a software design pattern that structures an application as a collection of loosely coupled, small, independent services. Each microservice is designed to perform a specific business function and can be deployed and executed independently of other services. This separation of services allows for greater flexibility, scalability, and maintainability compared to a monolithic architecture, where an application is built as a single, tightly coupled entity.

For example, the different microservices of quoting application (125) may communicate with each other through APIs or messaging systems, with each service being responsible for its own data storage. This enables different carrier specific APIs (135) to be developed and deployed independently, using different programming languages, frameworks, and databases as needed.

In one or more examples, the carrier specific APIs (135) enable quoting application (125) to integrate with applications and services deployed outside of the data platform. These carrier specific APIs (135) having implementation specific endpoints that are directly integrated with the web services for the different carriers. For example, via, quoting application (125) may expose a set of RESTful APIs for publishing and consuming service status messages that are compliant with quoting application (125) for each stage of a workflow. APIs for these direct integrations are built to receiving a quote for an insurance policy.

When a microservices architecture is utilized, quoting application (125) may enable GUI (115) to resolve one or more difficulties in creating a sequential GUI for obtaining online quotes for insurance policies. In one or more embodiments, GUI (115) solves one or more problems of prior GUI devices and sequential GUI devices, in the context of computerized insurance transactions, relating to one or more of state management, navigation, validation, flexibility, error handling, and testing.

For example, quoting application (125) may provide state management, enabling GUI (115) to manage the state of the interface, such as which step the user is currently on and what information has been entered. GUI (115) facilitate easier navigation, ensuring that the user can easily move between steps in the application process of the Quoting application (125), and providing clear feedback on the user's progress. Quoting application (125) may enable GUI (115) to validate user input as the user progresses through the steps, considering different validation rules for different steps. Quoting application (125) enables GUI (115) to be more flexible than other progressive interfaces, as it guides the user through a set sequence of steps. The microservices architecture may enable developers more easily to amend the interface or add new features later on.

In some illustrative examples, quoting application (125) can use an artificial intelligence system that includes one or more machine learning models (150) to make assumptions regarding data that may be required by web services (140) to obtain a quote for an insurance product. The artificial intelligence system comprises at least one of an artificial neural network, a cognitive system, a Bayesian network, a fuzzy logic, an expert system, a natural language system, or some other suitable system. Machine learning is used to train the artificial intelligence system. Machine learning involves inputting data to the process and allowing the process to adjust and improve the function of the artificial intelligence system.

In this illustrative example, the machine learning models (150) can use various types of algorithms to learn based on training data input into the model. These algorithms can include at least one of a supervised learning, an unsupervised learning, a feature learning, a sparse dictionary learning, anomaly detection, association rules, or other types of learning algorithms Examples of machine learning models include an artificial neural network, a decision tree, a support vector machine, a Bayesian network, a genetic algorithm, and other types of models. After training with an appropriate data set, the machine learning models (150) can process additional data to provide a desired output.

For example, when data that is required by web services (140) is missing or unavailable, quoting application (125) may use machine learning models (150), such as a classification tree or regression tree, to impute the necessary values. In general, Classification and Regression Trees (CART) and boosted regression trees (BRTs) use a decision tree algorithm for imputation of a categorical variable and a continuous or ordinal variable. The final nodes of the trees are used as imputation cells using the predicted category for the categorical variable and the predicted value for the continuous variable. Any tree algorithm using different imputation methods can be used in this way for imputation, such as AutoImpute, AMELIA, GUIDE, value substitution (mean/median/frequency/constant), K nearest neighbor, multivariate chained equation (MICE), stochastic regression, and hot-deck imputation.

To avoid overwhelming the user, the progression of GUI (115) does not overburden the user with questions. Rather, the quoting application (125) makes various assumptions, based on information retrieved from third-party data sources and the client device. For example, using one or more machine learning models, application server (120) may generate between 50 to 100 different assumptions on the back end based on modeled agent knowledge. Using one or more machine learning models (150), the assumptions can be based on a training corpus of about 45 million quotes that have run on the platform by live agents. The trained models mimic the decisions a live agent would make when presented with similar parameters.

For example, live agents may process thousands of quotes per day, issuing thousands of policies, which can be stored raw or as reports in data repository (160). The reports may, for example, provide insight into coverage types and limits of policies within a particular geolocation. Using machine learning models (150), the quoting application (145) can perform millions of different permutations, producing the optimal bundle of insurance products and coverage options from a plurality of different carriers.

Rather than a real time like algorithm, the quoting application may provide quotes based on the volume of quotes that have been previously run on the platform. For example, given a 5,000 square feet home that is located in Southlake, Texas, the quoting application considers relevant factors and can recommend, based on the prior quotes and policies provided by live agents, to insure the home at an appropriate replacement cost per square foot relative to the geographic location and not based on statewide defaults.

In other illustrative examples, the quoting application (145) may include or exclude policy options. Policy options can be added as a rider or endorsement to an existing insurance policy. Both an endorsement and a rider are both types of documents that can be used to add or modify coverage in an insurance policy. However, the terms are often used interchangeably, and the exact definition of each term may vary depending on the context and the insurance company.

For example, an endorsement is a document that amends or adds to the terms of an existing insurance policy. Policy endorsements are typically used to add coverage for specific risks or situations that were not included in the original policy. It is used to amend coverage, add, or remove coverage, or make other adjustments to the policy. An endorsement is attached to the original policy, and it becomes a part of the policy.

As another example, a rider can be used to add coverage for specific risks or situations that were not included in the original policy, or to adjust the policy to reflect a change in the policyholder's circumstances. Once approved, the policyholder may be required to pay an additional premium for the riders added.

For example, based on the prior quotes and policies provided by live agents, the quoting application may recognize that 98% of people who buy a Pennsylvania auto policy take a first set of coverage options, but do not take a second set of coverage options. The quoting application may quote location specific coverages, defaulting to the norms based on the quotes and policies submitted from the live agents.

Data repository (160) may store information retrieved from third-party data sources (130), web services (140), or machine learning models (150). The data repository (160) is any type of storage unit and/or device (e.g., a file system, database, data structure, or any other storage mechanism) for storing data. Further, the data repository (160) may include multiple different, potentially heterogeneous, storage units and/or devices.

In one or more embodiments of the invention, the data repository (160) may be spread across one or more computer-readable storage media, and may be or include one or more relational databases, hierarchical databases, object-oriented databases, one or more flat files, one or more spreadsheets, and/or one or more structured files. Data repository (160) may be managed by one or more database management systems (not depicted), which may be based on a technology such as Microsoft SQL Server, MySQL, Oracle Relational Database Management System (RDBMS), PostgreSQL, a NoSQL database technology, and/or any other appropriate technology.

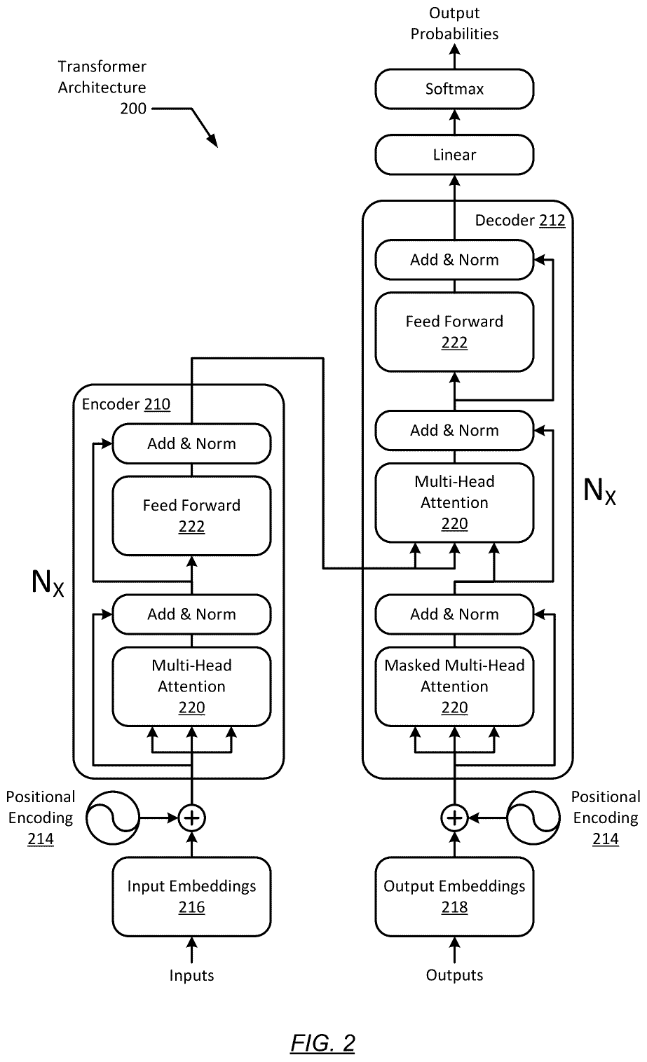

FIG. 2 illustrates a transformer architecture. Transformer architecture (200) can be used to implement the large language model (114) and/or the machine learning model(s) (118) of FIG. 1.

The transformer architecture (200) relies on a self-attention (intra-attention) mechanism, thereby eliminating the recurrent operations computed in Recurrent Neural Networks, which may be used to compute the latent space representation of both the encoder (210) and decoder (212) sides. Positional encoding (214) is added to the input and output embeddings (216, 218) with the absence of recurrence. The positional information, which is similar to a time-step in a recurrent network, provides the Transformer network with the order of input and output sequences. A combination of absolute positional encoding and relative positional information may be used. Input from the previously generated symbol is auto-regressively used by the model for the next prediction which is organized as a stack of encoder-decoder networks. In addition, uniform layers compose both the encoder (210) and decoder (212), and each layer is built of two sublayers: a multi-head self-attention layer (220) and a position-wise feed-forward network (FFN) layer (222). The multi-head sub-layer (220) enables the use of multiple attention functions with an equivalent cost of utilizing attention, while the FFN sub-layer (222) uses a fully connected network to process the attention sublayers. The FFN applies multiple linear transformations on each position and a Rectified Linear Unit (ReLU) which extends the self-attention mechanism to efficiently consider representations of the relative positioning (i.e., distances between sequence elements).

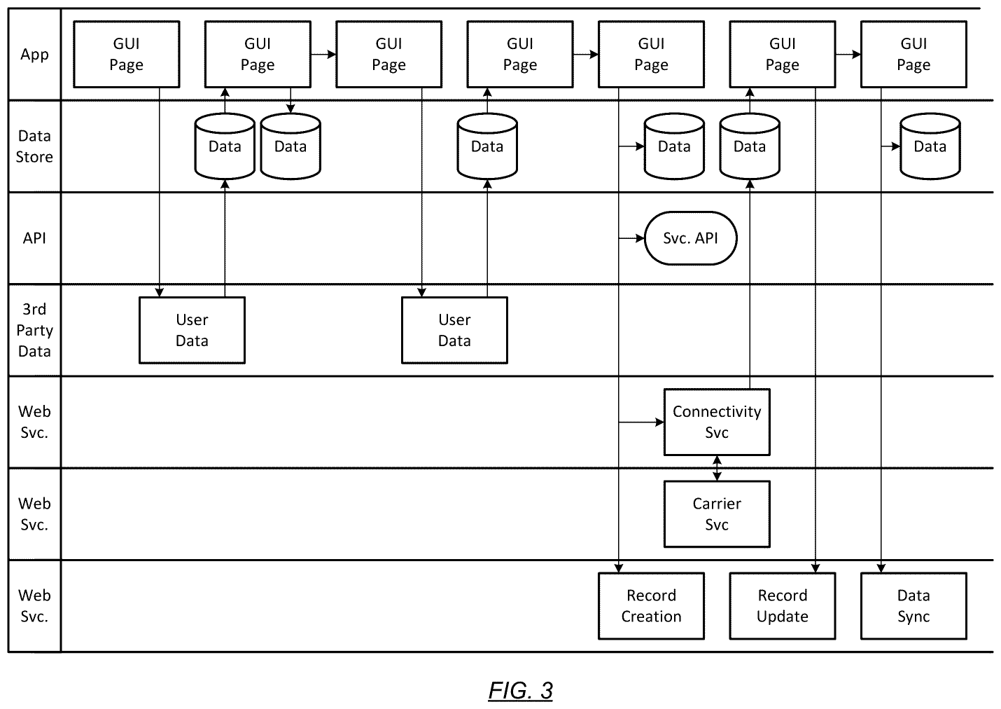

Referring now to FIG. 3, a system flow diagram is shown according to illustrative embodiments. These system flow of FIG. 3 illustrates data flowing between the different components of Quoting application (100) of FIG. 1.

The dataflow shown illustrated in FIG. 3 may utilize a Salesforce back-end using Heroku React Node.JS and a PostgreSQL database. Information is pulled from Salesforce and the logic in the app is applying before sending the information out to a MuleSoft integration platform. Carrier responses are sent back to the data platform where they synchronized with the local database, backed-up to Salesforce, and displayed in the user interface.

The dataflow complexities are compounded when this dataflow is scaled upwards to work with hundreds of carriers that can be integrated onto the platform. Each of the carriers may work differently, using carrier-specific APIs that may require different or missing information.

While FIGS. 1-3 show a configuration of components, other configurations may be used without departing from the scope of the invention. For example, various components may be combined to create a single component. As another example, the functionality performed by a single component may be performed by two or more components.

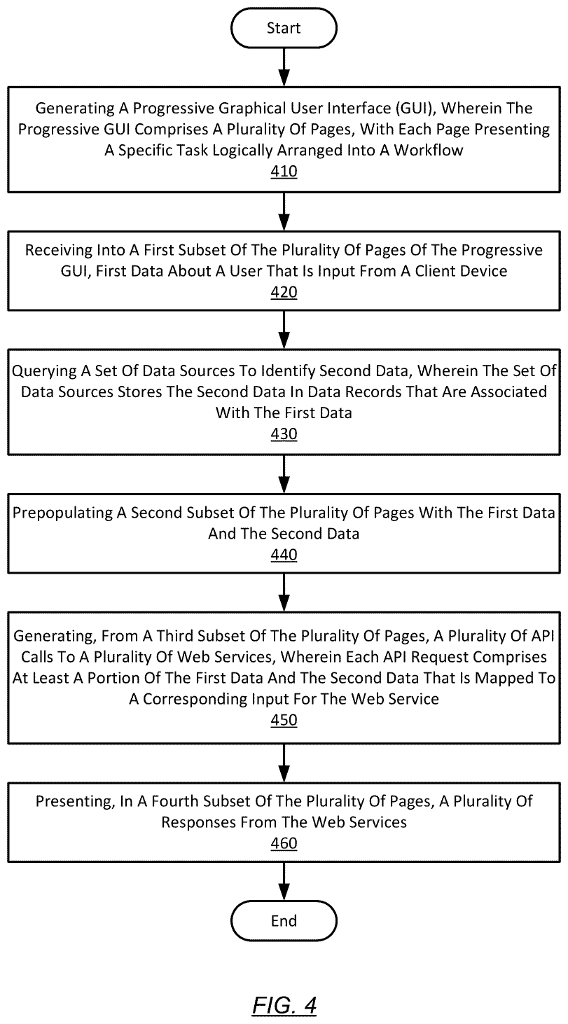

Turning to FIG. 4, a method in an agent facing computer system is shown according to one or more illustrative embodiments. The method four can be implemented in one or more components of the computer system illustrated in FIG. 1, such as quoting application (125).

While the various steps in this flowchart are presented and described sequentially, at least some of the steps may be executed in different orders, may be combined, or omitted, and at least some of the steps may be executed in parallel. Furthermore, the steps may be performed actively or passively.

At step 410, a progressive graphical user interface (GUI) is generated. The progressive GUI comprises a plurality of pages. Each page presenting a specific task logically arranged into a workflow. In some embodiments, the workflow presented in the progressive GUI is an application for an insurance policy.

At step 420, a first subset of the plurality of pages of the progressive GUI receives first data about a user that is input from a client device. In some embodiments, the first subset of the plurality of pages includes a first page for receiving first data comprising personal identifying information about the user. In some embodiments, the first subset of the plurality of pages includes a first page for receiving first data about a home property. In some embodiments, the first subset of the plurality of pages includes a first page for receiving first data about an automobile.

At step 430, a set of data sources is queried to identify second data, wherein the set of data sources stores the second data in data records that are associated with the first data.

At step 440, a second subset of the plurality of pages is prepopulated with the first data and the second data. In some embodiments, the second subset of the plurality of pages includes a second page that is prepopulated with the second data about the home property. In some embodiments, the second subset of the plurality of pages includes a second page that is prepopulated with the second data about the automobile.

At step 450, a plurality of API calls is generated from a third subset of the plurality of pages to a plurality of web services. Each API call comprises at least a portion of the first data and the second data that is mapped to a corresponding input for the web service. For example, the first data and the second data can be packaged into a JavaScript object notation (JSON) object, with the plurality of API calls including the JSON object.

At step 460, a plurality of responses from the web services are presented in a fourth subset of the plurality of pages.

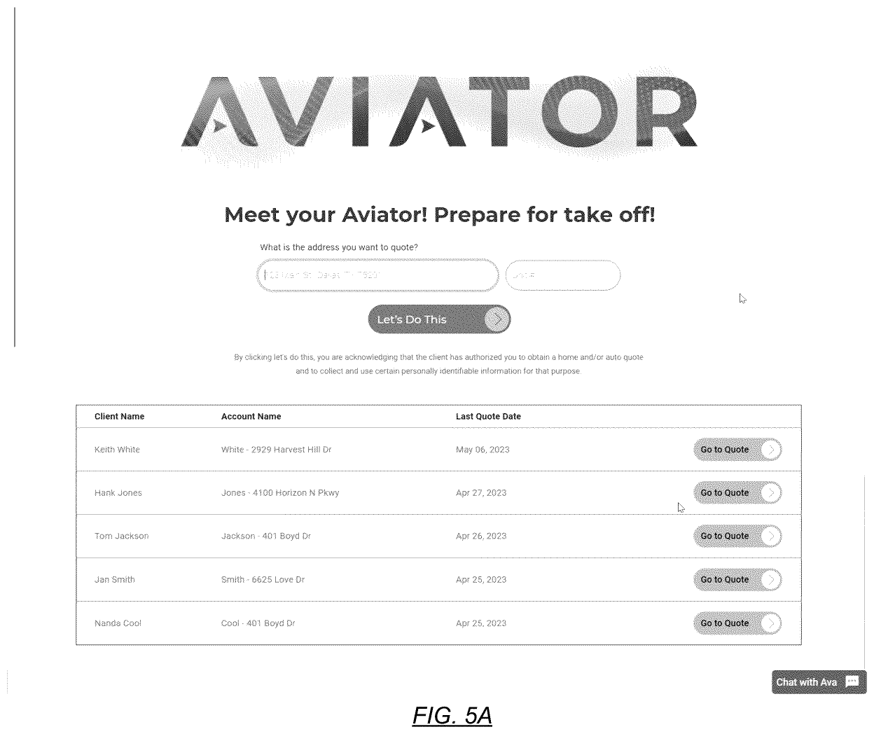

Turning to FIGS. 5-11, a series of pages in a progressive graphical user interface is according to illustrative embodiments. Pages illustrated in FIGS. 5-11 can be used to implement a particular use case of obtaining an online insurance quote. The following example is for explanatory purposes only and not intended to limit the scope of the invention.

FIGS. 5A and 5B show a first page of a progressive graphical user interface. As depicted, page (500) of the graphical user interface is a landing page for a quoting application to get an insurance quote. FIG. 5A may include a Google API driven smart list, where a background process looks up the user's address as they start typing it into the page. Clicking the address brings the user to a series of questions about the home located at the selected address. Depending on the user's answers, supplementary questions may potentially pop up that solicit additional information that correlate to the user's answers. In one embodiment, page (500) may also enable the user to forgo home insurance quotes and select an option to receive only quotes for auto insurance.

As depicted in FIG. 5B, window (510) is displayed in response to a selection of a control element on page (500) for launching an integrated chatbot. window (510) may be displayed as a subsequent page of the graphical user interface, or as an overlay or a pop-up atop page (500).

A chatbot is a computer program designed to simulate human conversation and interact with users through a messaging interface, like a chat window or messaging app. The goal of a chatbot is to provide useful information, answer questions, and engage in conversation with users in a natural and human-like manner.

On the back end, the chatbot uses Natural Language Processing (NLP) techniques to understand the user's input and extract the intent or meaning behind it. NLP helps the chatbot process the text and determine what action or response is required. A large language model (LLM) can then be used to generate responses based on the input received from the user. These LLMs may be offered through APIs (Application Programming Interfaces), allowing the chatbot to interact with the language model and send input text to receive responses that are both contextually relevant and coherent.

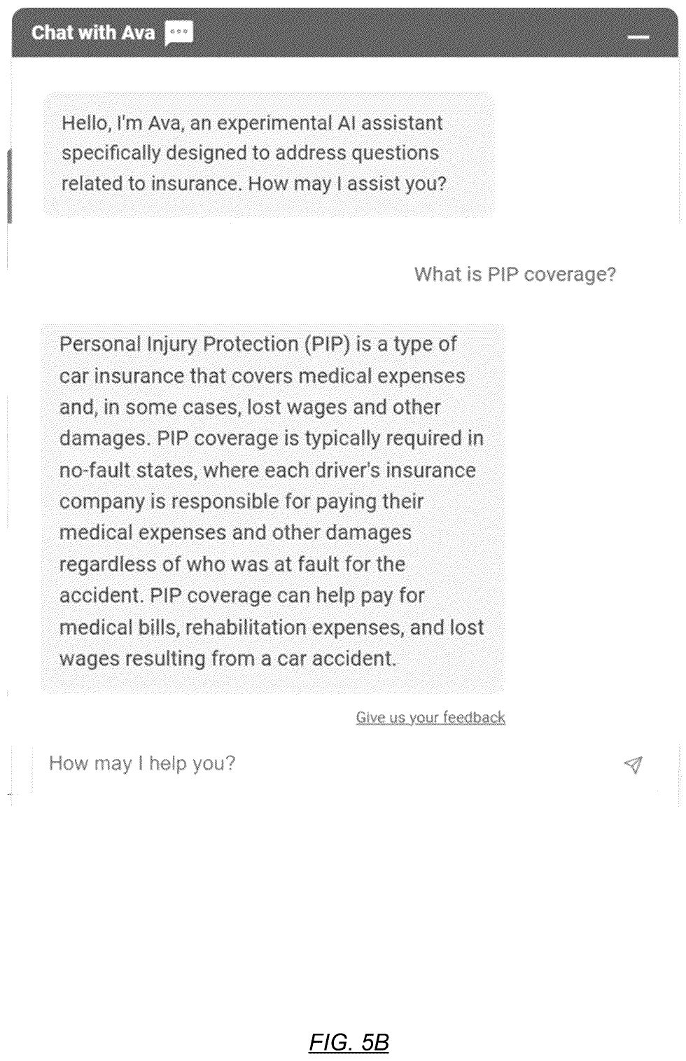

FIGS. 6A, 6B and 6C show second pages of the progressive graphical user interface. Pages (600) and (610) may progressively solicit additional information is about a user's home and the information submitted into page (500) of FIG. 5.

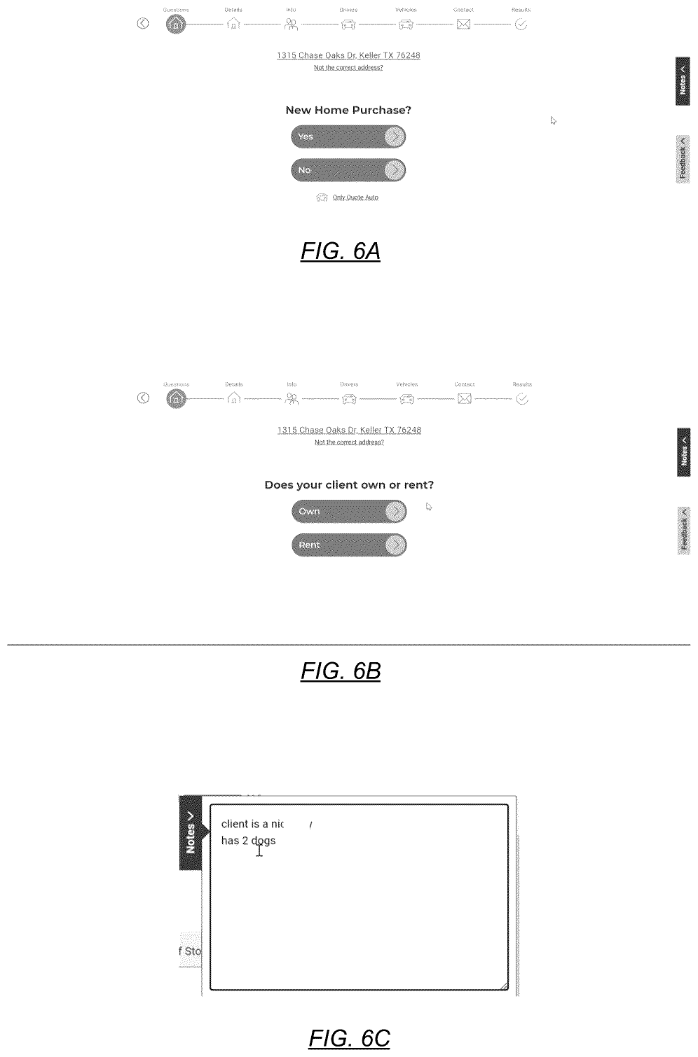

FIG. 7 is a third page of the progressive graphical user interface. Information pulled from a third-party data source, such as one of data sources (130) of FIG. 1, is populated into the various fields of page (700). As illustrated, the information is about a user's home. Any updates that are potentially needed can be edited by the user. Selecting a field enables the user to edit the retrieved information, updating any incorrect or outdated data. page (700) may also allow the user to enter data about a rider or an endorsement (shown as “jewelry coverage”) to be added to the insurance policy.

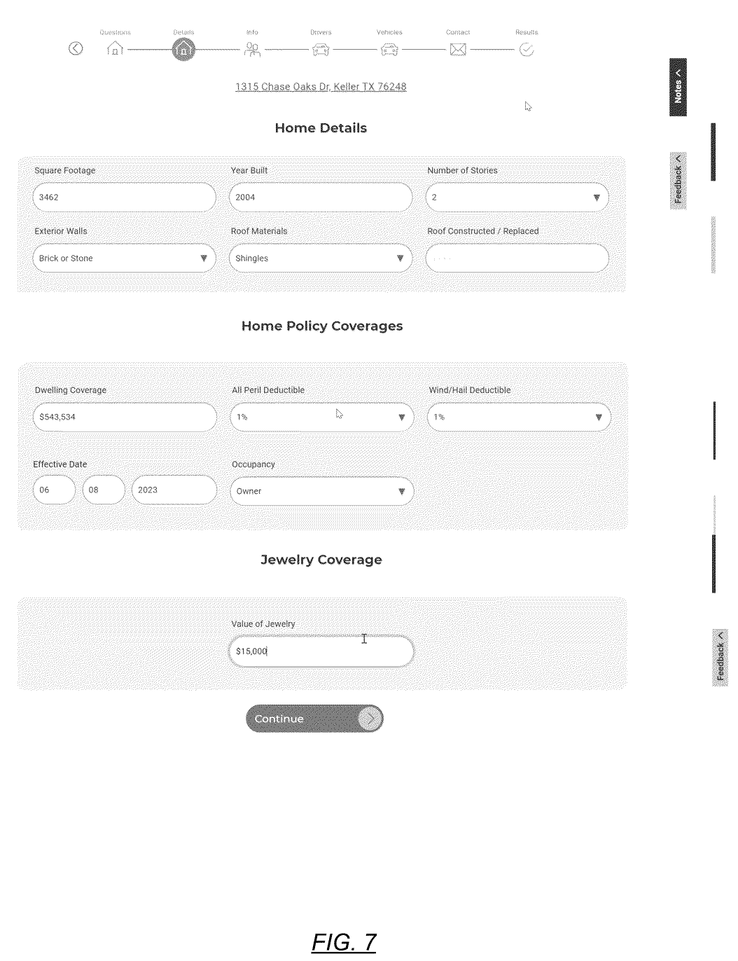

FIG. 8 is a fourth page of the progressive graphical user interface. As illustrated, the information is personal information frequently used to obtain a home policy quote. Any updates that are potentially needed can be edited by the client. Selecting a field enables the user to edit the information that was retrieved, updating any incorrect or outdated data.

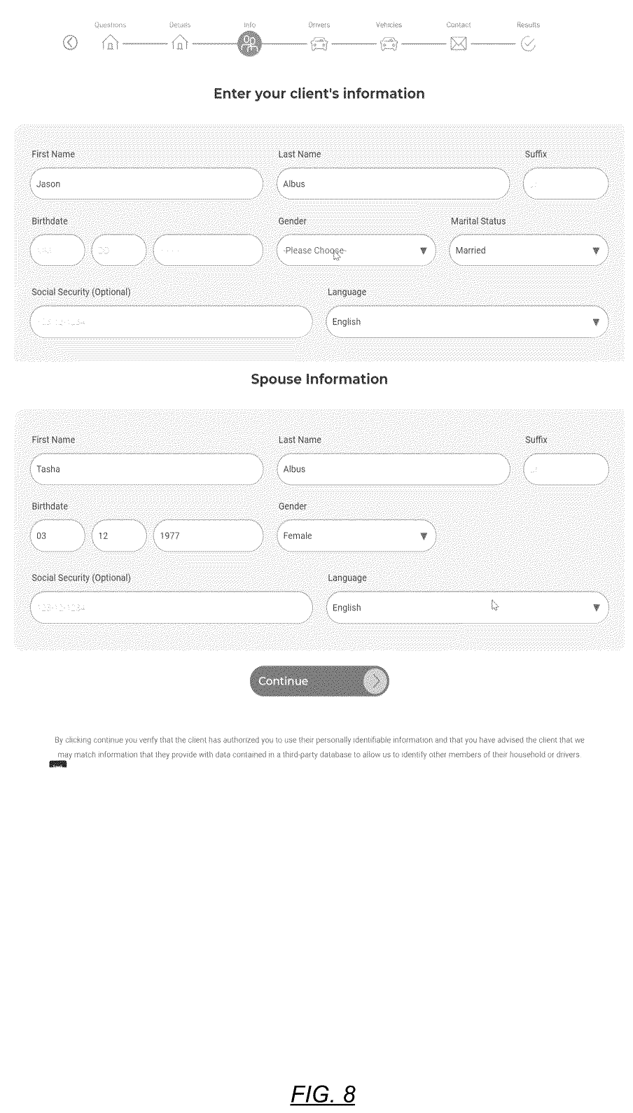

FIGS. 9A, 9B and 9C are fifth pages of the progressive graphical user interface. Page (900) asks about drivers that should be included on the auto policy, and again pulling information from local and third-party data sources. The user can add a driver if needed. The user may also indicate if only a quote for the home is requested.

Information in Page (900) can be pulled from a third-party data source, such as one of the data sources (130) of FIG. 1 and can be populated into the various fields of page (900). As illustrated, the information is personal information frequently used to obtain an auto policy quote. Any updates that are potentially needed can be edited by the client. Selecting a field enables the user to edit the information that was retrieved, updating any incorrect or outdated data.

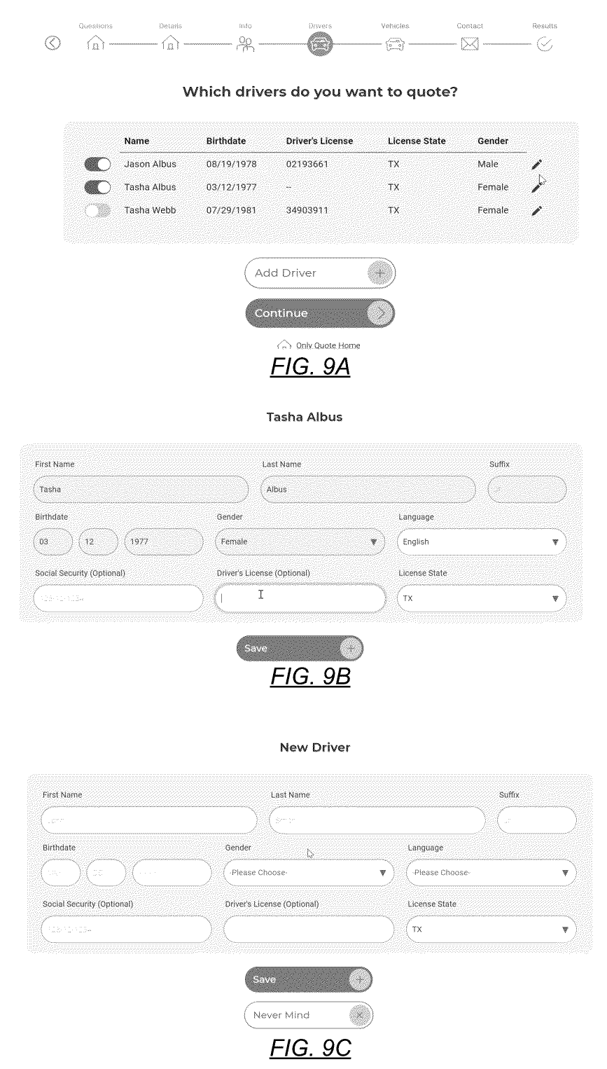

FIGS. 10A, 10B and 10C are sixth pages of the progressive graphical user interface. Information can be pulled from a third-party data source, such as one of data sources (130) of FIG. 1 and can be populated into the various fields of pages (1000). As shown in the progression of FIGS. 10A, 10B and 10C, page (1000) progressively solicits additional information about the user and the user's vehicles to be included in the policy quote.

In FIG. 10A, the page (1000) displays a list of the user's vehicles. In FIG. 10B, page (1000) may additionally enable the user to edit a purchase date and primary usage of the vehicle. Based on these few data points that are collected, as well as data previously submitted and prior quotes, the quoting application can recommend limits and terms for the quoted policy coverage. In FIG. 10B, page (1000) may additionally enable the user to add additional vehicles to the policy.

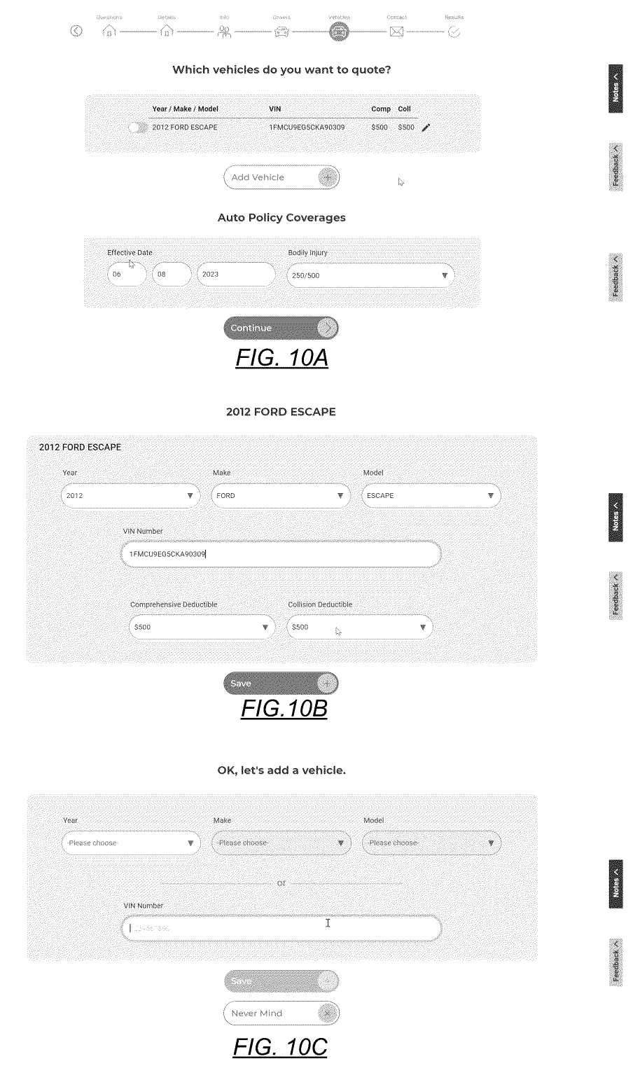

FIG. 11 is a seventh page of the progressive graphical user interface. Page (1500) will ask for contact information for the user, such as an e-mail and phone number. Selecting the “Submit” button triggers the background execution of the quoting dataflow illustrated in FIG. 2.

In response to the selection, the background process collects and packages the user's information, such as in a JSON object, which is distributed to the other insurance providers. For example, the packaged information can be sent to a MuleSoft integration platform, which sends those data points to multiple carriers and receives quotes from those carriers based on the information. Quotes can be solicited from the multiple carriers both as a bundled package and as individual offerings.

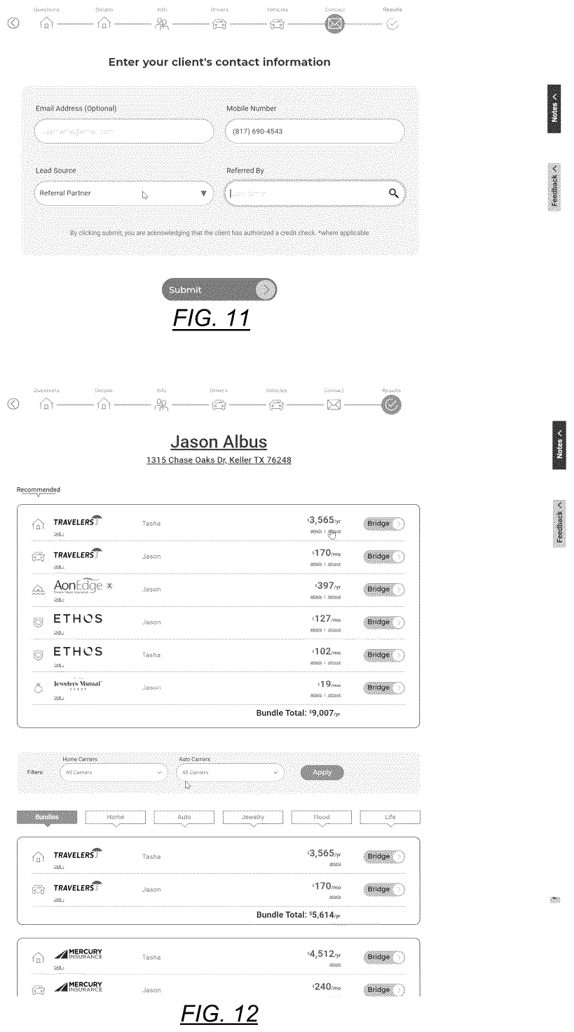

FIG. 12 is an eighth page of the progressive graphical user interface. Responses sent back from the different carriers are collected and displayed in the response screen of page (1200), including quotes provided by the different carriers for each requested insurance product. Quotes from the different carriers can be displayed both as a bundled package and as individual offerings.

In some embodiments, the process may automatically select two different carriers as the best bundled option. In other embodiments, a single carrier may be selected as providing the lowest cost based on the user's information, changing the quoted products. For each carrier, quotes are run under both individual and bundled scenarios. Logic provided, for example within the quoting application (145) of FIG. 1, mixes and matches possible combinations of quotes from the different carriers behind the scenes to determine a suggested option.

In one or more embodiments, a more in-depth questionnaire can be presented to the user, including the details of the real property that are needed to bind the home and auto policies. The questionnaire may ask a series of questions, determined by either or both of these service provider or individual carriers, coming to an agreement on like what is necessary to bind the policy. At any point, the user can update the data, and an updated policy information is displayed in near real-time as information affecting the quote is pulled from either were both of the carrier and local data sources.

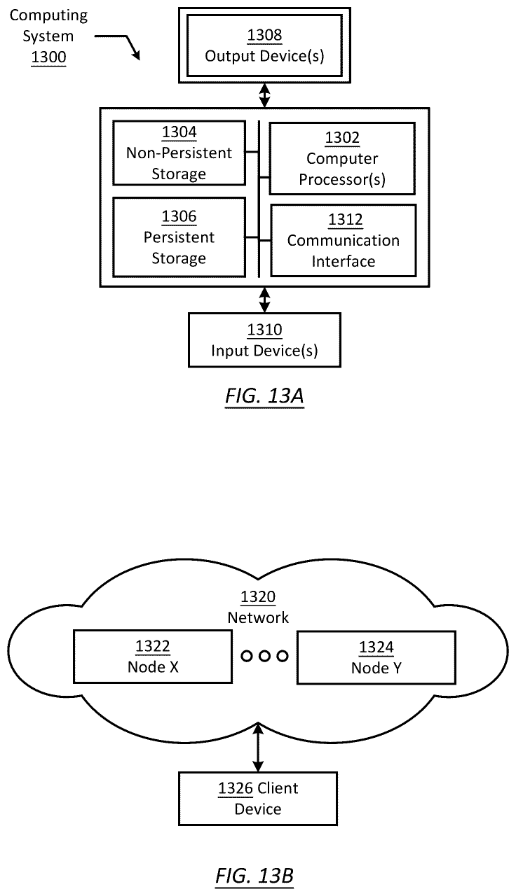

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 13A, the computing system (1300) may include one or more computer processor(s) (1302), non-persistent storage (1304), persistent storage (1306), a communication interface (1312) (e.g., Bluetooth interface, infrared interface, network interface, optical interface, etc.), and numerous other elements and functionalities that implement the features and elements of the disclosure. The computer processor(s) (1302) may be an integrated circuit for processing instructions. The computer processor(s) may be one or more cores or micro-cores of a processor. The computer processor(s) (1302) includes one or more processors. The one or more processors may include a central processing unit (CPU), a graphics processing unit (GPU), a tensor processing units (TPU), combinations thereof, etc.

The input devices (1310) may include a touchscreen, keyboard, mouse, microphone, touchpad, electronic pen, or any other type of input device. The input devices (1310) may receive inputs from a user that are responsive to data and messages presented by the output devices (1308). The inputs may include text input, audio input, video input, etc., which may be processed and transmitted by the computing system (1300) in accordance with the disclosure. The communication interface (1312) may include an integrated circuit for connecting the computing system (1300) to a network (not shown) (e.g., a local area network (LAN), a wide area network (WAN) such as the Internet, mobile network, or any other type of network) and/or to another device, such as another computing device.

Further, the output devices (1308) may include a display device, a printer, external storage, or any other output device. One or more of the output devices may be the same or different from the input device(s). The input and output device(s) may be locally or remotely connected to the computer processor(s) (1302). Many different types of computing systems exist, and the aforementioned input and output device(s) may take other forms. The output devices (1308) may display data and messages that are transmitted and received by the computing system (1300). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (1300) in FIG. 13A may be connected to or be a part of a network. For example, as shown in FIG. 13B, the network (1320) may include multiple nodes (e.g., node X (1322), node Y (1324)). Each node may correspond to a computing system, such as the computing system shown in FIG. 13A, or a group of nodes combined may correspond to the computing system shown in FIG. 13A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1300) may be located at a remote location and connected to the other elements over a network.

The nodes (e.g., node X (1322), node Y (1324)) in the network (1320) may be configured to provide services for a client device (1326), including receiving requests and transmitting responses to the client device (1326). For example, the nodes may be part of a cloud computing system. The client device (1326) may be a computing system, such as the computing system shown in FIG. 13A. Further, the client device (1326) may include and/or perform all or a portion of one or more embodiments of the invention.

The computing system of FIG. 13A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such includes the term “and.” Further, items joined by the term “or” may include any combination of the items with any number of each item unless, expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method in an agent facing computer system, the method comprising:
generating a progressive graphical user interface (GUI), wherein the progressive GUI comprises a plurality of pages, with each page presenting a specific task logically arranged into a workflow;
receiving into a first subset of the plurality of pages of the progressive GUI, first data about a user that is input from a client device;
querying a set of data sources to identify second data, wherein the set of data sources stores the second data in data records that are associated with the first data;
prepopulating a second subset of the plurality of pages with the first data and the second data;
generating, from a third subset of the plurality of pages, a plurality of API calls to a plurality of web services, wherein each API request comprises at least a portion of the first data and the second data that is mapped to a corresponding input for the web service; and
presenting, in a fourth subset of the plurality of pages, a plurality of responses from the web services.

2. The method of claim 1, wherein the workflow presented in the progressive GUI is an application for an insurance policy.

3. The method of claim 2, wherein the first subset of the plurality of pages includes a first page for receiving first data comprising personal identifying information about the user.

4. The method of claim 2, wherein the first subset of the plurality of pages includes a first page for receiving first data about a home property.

5. The method of claim 4, wherein the second subset of the plurality of pages includes a second page that is prepopulated with the second data about the home property.

6. The method of claim 2, wherein the first subset of the plurality of pages includes a first page for receiving first data about an automobile.

7. The method of claim 4, wherein the second subset of the plurality of pages includes a second page that is prepopulated with the second data about the automobile.

8. The method of claim 2, wherein the first subset of the plurality of pages includes a page for receiving first data about a rider or an endorsement to be added to the insurance policy.

9. The method of claim 1, further comprising:
packaging the first data and the second data into a JavaScript object notation (JSON) object, wherein the plurality of API calls includes the JSON object.

10. A graphical user interface in an agent facing computer system, the graphical user interface comprises:
a progressive graphical user interface (GUI), wherein the progressive GUI comprises a plurality of pages, with each page presenting a specific task logically arranged into a workflow, wherein the plurality of pages further comprises:
a first subset of the plurality of pages configured to receive first data about a user that is input from a client device;
a second subset of the plurality of pages prepopulated with the first data and second data identified by querying a set of data sources, wherein the set of data sources stores the second data in data records that are associated with the first data;
a third subset of the plurality of pages configured to generate a plurality of API calls to a plurality of web services, wherein each API request comprises at least a portion of the first data and the second data that is mapped to a corresponding input for the web service; and
a fourth subset of the plurality of pages configured to present a plurality of responses from the web services.

11. The graphical user interface of claim 10, wherein the workflow presented in the progressive GUI is an application for an insurance policy.

12. The graphical user interface of claim 11, wherein the first subset of the plurality of pages includes a first page for receiving first data comprising personal identifying information about the user.

13. The graphical user interface of claim 11, wherein the first subset of the plurality of pages includes a first page for receiving first data about a home property.

14. The graphical user interface of claim 13, wherein the second subset of the plurality of pages includes a second page that is prepopulated with the second data about the home property.

15. The graphical user interface of claim 11, wherein the first subset of the plurality of pages includes a first page for receiving first data about an automobile.

16. The graphical user interface of claim 15, wherein the second subset of the plurality of pages includes a second page that is prepopulated with the second data about the automobile.

17. The graphical user interface of claim 11, wherein the first subset of the plurality of pages includes a page for receiving first data about a rider or an endorsement to be added to the insurance policy.

18. The graphical user interface of claim 10, further comprising:
packaging the first data and the second data into a JavaScript object notation (JSON) object, wherein the plurality of API calls comprises the JSON object.

19. A system comprising:
a data repository storing an advice library comprising an ontology of action logic formatted as a set of machine-interpretable logic descriptions; and
a computer processor for executing an advice planner that is configured to:
generate a progressive graphical user interface (GUI), wherein the progressive GUI comprises a plurality of pages, with each page presenting a specific task logically arranged into a workflow;
receive into a first subset of the plurality of pages of the progressive GUI, first data about a user that is input from a client device;
query a set of data sources to identify second data, wherein the set of data sources stores the second data in data records that are associated with the first data;
prepopulate a second subset of the plurality of pages with the first data and the second data;
generate, from a third subset of the plurality of pages, a plurality of API calls to a plurality of web services, wherein each API request comprises at least a portion of the first data and the second data that is mapped to a corresponding input for the web service; and
present, in a fourth subset of the plurality of pages, a plurality of responses from the web services.

20. The system of claim 19, wherein the workflow presented in the progressive GUI is an application for an insurance policy.
